(19) United States
(12) Patent Application Publication
(10) Pub. No.: US 2005/0271280 A1
(43) Pub. Date: Dec. 8, 2005

(54) System or method for classifying images

(76) Inventors: Michael E. Farmer, West Bloomfield, MI (US); Xunchang Chen, Ann Arbor, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/625,208

(22) Filed: Jul. 23, 2003

(51) Int. Cl. G06K 9/62; G06K 9/00

(52) U.S. Cl. 382/224; 382/104

(57) ABSTRACT

A system or method (collectively “classification system”) is disclosed for classifying sensor images into one of several pre-defined classifications. Mathematical moments relating to various features or attributes in the sensor image are used to populated a vector of attributes, which are then compared to a corresponding template vector of attribute values. The template vector contains values for known classifications which are preferably predefined. By comparing the two vectors, various votes and confidence metrics are used to ultimately select the appropriate classification. In some embodiments, preparation processing is performed before loading the attribute vector with values. Image segmentation is often desirable. The performance of heuristics to adjust for environmental factors such as lighting can also be desirable. One embodiment of the system is to prevent the deployment of an airbag when the occupant in the seat is a child, a rear-facing infant seat, or when the seat is empty.

### BACKGROUND OF THE INVENTION

The present invention relates in general to a system or method (collectively “classification system”) for classifying images captured by one or more sensors.

Human beings are remarkably adept at classifying images. Although automated systems have many advantages over human beings, human beings maintain a remarkable superiority in classifying images and other forms of associating specific sensor inputs with general categories of sensor inputs. For example, if a person watches video footage of a human being pulling off a sweater over their head, the person is unlikely to doubt the continued existence of the human being's head simply because the head is temporarily covered by the sweater. In contrast, an automated system in that same circumstance may have great difficulty in determining whether a human being is within the image due to the absence of a visible head. In the analogy of not seeing the forest for the trees, automated systems are excellent at capturing detailed information about various trees in the forest, but human beings are much better at classifying the area as a forest. Moreover, human beings are also better at integrating current data with past data.

Advances in the capture and manipulation of digital images continues at a rate that far exceeds improvements in classification technology. The performance capabilities of sensors, such as digital cameras and digital camcorders, continue to rapidly increase while the costs of such devices continue to decrease. Similar advances are evident with respect to computing power generally. Such advances continue to outpace developments and improvements with respect to classification systems, and other image processing technologies that make use of the information captured by the various sensor systems.

There are many reasons why existing classification systems are inadequate. One reason is the failure of such technologies to incorporate past conclusions in making current classifications. Another reason is the failure to attribute a confidence factor with classification determinations. It would be desirable to incorporate past classifications, and various confidence metrics associated with those past classifications, into the process of generating new classifications. In the example of a person pulling off a sweater, it would be desirable for the classification system to be able to use the fact that mere seconds earlier, an adult human being was confidently identified as sitting in the seat. Such a context should be used to assist the classification system in classifying the apparently “headless” occupant.

Another reason for classification failures is the application of a one-size-fits-all approach with respect to sensor conditions. For example, visual images captured in a relatively dark setting such as at night time, will typically be of lower contrast than images captured in a relatively bright setting, such as at noon on a sunny day. It would be desirable for the classification system to apply different processes, techniques, and methods (collectively “heuristics”) for preparing images for classification based on the type of environmental conditions.

“Sensory overload” is another reason for poor classification performance. Unlike human beings who typically benefit from additional information, automated classification systems function better when they focus on the relatively fewer attributes or features that have proven to be the most useful in distinguishing between the various types of classifications distinguished by the particular classification system.

Many classification systems use parametric heuristics to classify images. Such parametric techniques struggle to deal with the immense variability of the more difficult classification environments, such as those environments potentially involving human beings as the target of the classification. It would be desirable for a classification system to make classification determinations using non-parametric processes.

### SUMMARY OF THE INVENTION

The invention is a system or method (collectively “classification system” or simply “system”) for classifying images.

The system invokes a vector subsystem to generate a vector of attributes from the data captured by the sensor. The vector of attributes incorporates the characteristics of the sensor data that are relevant for classification purposes. A determination subsystem is then invoked to generate a classification of the sensor data on the basis of processing performed with respect to the vector of attributes created by the vector subsystem.

In many embodiments, the form of the sensor data captured by the sensor is an image. In other embodiments, the sensor does not directly capture an image, and instead the sensor data is converted into an image representation. In some embodiments, images are “pre-processed” before they are classified. Pre-processing can be automatically customized with respect to the environmental conditions surrounding the capture of the image. For example, images captured in daylight conditions can be subjected to a different preparation process than images captured in nighttime conditions. The pre-processing preparations of the classification system can in some embodiments, be combined with a segmentation process performed by a segmentation subsystem. In other embodiments, image preparation and segmentation are distinctly different processes performed by distinctly different classification system components.

Historical data relating to past classifications can be used to influence the current classification being generated by the determination subsystem. Parametric and non-parametric heuristics can be used to compare attribute vectors with the attribute vectors of template images of known classifications. One or more confidence values can be associated with each classification, and in a preferred embodiment, a single classification is selected from multiple classifications on the basis of one or more confidence values.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a process flow diagram illustrating an example of a process beginning with the capture of sensor data from a target and ending with the generation of a classification by a computer.

FIG. 2 is an environmental diagram illustrating an example of a classification system being used to support the functionality of an airbag deployment mechanism in a vehicle.

FIG. 3 is a process flow diagram illustrating an example of a classification process flow in the context of an airbag deployment mechanism.

FIG. 4a is a diagram illustrating an example of an image that would be classified as a “rear facing infant seat” for the purposes of airbag deployment.

FIG. 4b is a diagram illustrating an example of an image that would be classified as a “child” for the purposes of airbag deployment.

FIG. 4c is a diagram illustrating an example of an image that would be classified as an “adult” for the purposes of airbag deployment.

FIG. 4d is a diagram illustrating an example of an image that would be classified as “empty” for the purposes of airbag deployment.

FIG. 5 is a block diagram illustrating an example of some of the processing elements of the classification system.

FIG. 6 is a process flow diagram illustrating an example of a subsystem-level view of the system.

FIG. 7 is a process flow diagram illustrating an example of a subsystem-level view of the system that includes segmentation and other pre-classification processing.

FIG. 8 is a block diagram illustrating an example of the segmentation subsystem and some of the elements that can be processed by the segmentation subsystem.

FIG. 9a is a diagram illustrating an example of a segmented image captured in daylight conditions.

FIG. 9b is a diagram illustrating an example of a segmented image captured in nighttime conditions.

FIG. 9c is a diagram illustrating an example of an outdoor light template image.

FIG. 9d is a diagram illustrating an example of an indoor light template image.

FIG. 9e is a diagram illustrating an example of a night template image.

FIG. 10a is a diagram illustrating an example of a binary segmented image.

FIG. 10b is a diagram illustrating an example of a boundary image.

FIG. 10c is a diagram illustrating an example of contour image.

FIG. 11a is a diagram illustrating an example of an interior edge image.

FIG. 11b is a diagram illustrating an example of a contour edge image.

FIG. 11c is a diagram illustrating an example of a combined edge image.

FIG. 12 is a block diagram illustrating an example of the vector subsystem, and some of the elements that can be processed by the vector subsystem.

FIG. 13 is a block diagram illustrating an example of the determination subsystem, and some of the processing elements of the determination subsystem.

FIG. 13a is a process flow diagram illustrating an example of a comparison heuristic.

FIG. 14 is a diagram illustrating some examples of k-Nearest Neighbor outputs as a result of the k-Nearest Neighbor heuristic being applied to various images.

FIG. 15 is a process flow diagram illustrating one example of a method performed by the classification system.

FIG. 16 is process flow diagram illustrating one example of a daytime pre-processing heuristic.

FIG. 17 is a process flow diagram illustrating one example of a night-time pre-processing heuristic.

FIG. 18 is a process flow diagram illustrating one example of a vector heuristic.

FIG. 19 is a process flow diagram illustrating one example of a classification determination heuristic.

### DETAILED DESCRIPTION

The invention is a system or method (collectively “classification system” or simply the “system”) for classifying images. The classification system can be used in a wide variety of different applications, including but not limited to the following:
airbag deployment mechanisms can utilize the classification system to distinguish between occupants where deployment would be desirable (e.g. the occupant is an adult), and occupants where deployment would be undesirable (e.g. an infant in a child seat);
security applications may utilize the classification system to determine whether a motion sensor was triggered by a human being, an animal, or even inorganic matter;
radiological applications can incorporate the classification system to classify x-ray results, automatically identifying types of tumors and other medical phenomenon;
identification applications can utilize the classification system to match images with the identities of specific individuals; and
navigation applications may use the classification system to identify potential obstructions on the road, such as other vehicles, pedestrians, animals, construction equipment, and other types of obstructions.

The classification system is not limited to the examples above. Virtually any application that uses some type of image as an input can benefit from incorporating

I. Introduction of Elements and Definitions

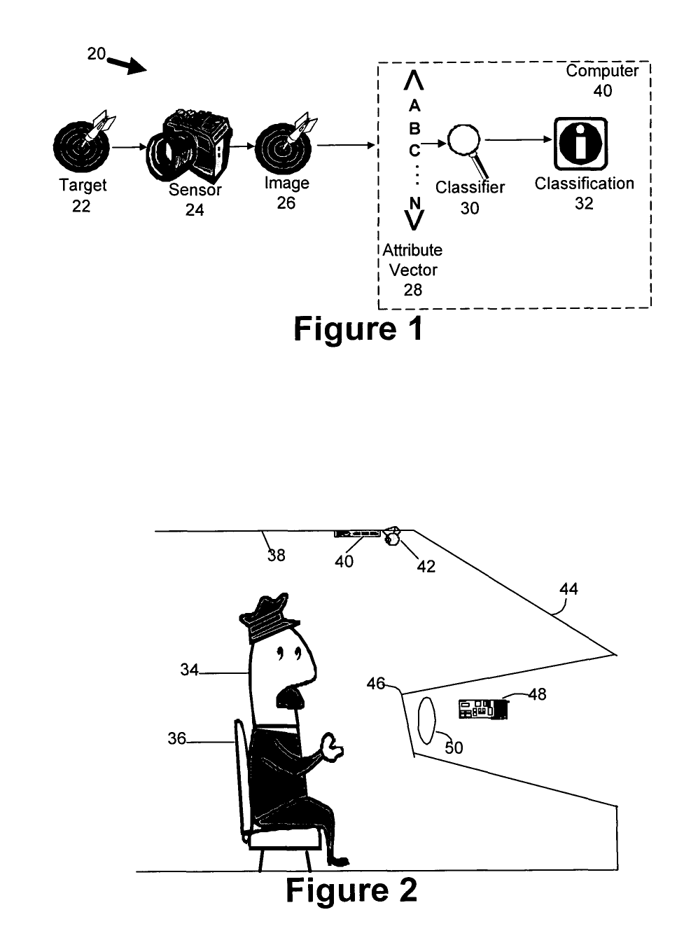

FIG. 1 is a high-level process flow diagram illustrating some of the elements that can be incorporated into a system or method for classifying images (“classification system” or simply the “system”) 20.

A. Target

A target 22 can be any individual or group of persons, animals, plants, objects, spatial areas, or other aspects of interest (collectively “target” 22) that is or are the subject or target of a sensor 24 used by the system 20. The purpose of the classification system 20 is to generate a classification 32 of the target 22 that is relevant to the application incorporating the classification system 20.

The variety of different targets 22 can be as broad as the variety of different applications incorporating the functionality of the classification system 20. In an airbag deployment or an airbag disablement (collectively “airbag”) embodiment of the system 20, the target 22 is an occupant in the seat corresponding to the airbag. The image 26 captured by the sensor 24 in such a context will include the passenger area surrounding the occupant, but the target 22 is the occupant. Unnecessary deployments and inappropriate failures to deploy can be avoided by the access of the airbag deployment mechanism to accurate occupant classifications. For example, the airbag mechanism can be automatically disabled if the occupant of the seat is classified as a child.

In other embodiments of the system 20, the target 22 may be a human being (various security embodiments), persons and objects outside of a vehicle (various external vehicle sensor embodiments), air or water in a particular area (various environmental detection embodiments), or some other type of target 22.

B. Sensor

A sensor 24 can be any type of device used to capture information relating to the target 22 or the area surrounding the target 22. The variety of different types of sensors 24 can vary as widely as the different types of physical phenomenon and human sensation. The type of sensor 24 will generally depend on the underlying purpose of the application incorporating the classification system 20. Even sensors 24 not designed to capture images can be used to capture sensor readings that are transformed into images 26 and processing by the system 20. Ultrasound pictures of an unborn child are one prominent example of the creation of an image from a sensor 24 that does not involve light-based or visual-based sensor data. Such sensors 24 can be collectively referred to as non-optical sensors 24.

The system 20 can incorporate a wide variety of sensors (collectively “optical sensors”) 24 that capture light-based or visual-based sensor data. Optical sensors 24 capture images of light at various wavelengths, including such light as infrared light, ultraviolet light, x-rays, gamma rays, light visible to the human eye (“visible light”), and other optical images. In many embodiments, the sensor 24 may be a video camera. In a preferred vehicle safety restrain embodiment, such as an airbag suppression application where the system 20 monitors the type of occupant, the sensor 24 can be a standard digital video camera. Such cameras are less expensive than more specialized equipment, and thus it can be desirable to incorporate “off the shelf” technology.

Non-optical sensors 24 focus on different types of information, such as sound (“noise sensors”), smell (“smell sensors”), touch (“touch sensors”), or taste (“taste sensors”). Sensors can also target the attributes of a wide variety of different physical phenomenon such as weight (“weight sensors”), voltage (“voltage sensors”), current (“current sensor”), and other physical phenomenon (collectively “phenomenon sensors”).

C. Target Image

A collection of target information can be any information in any format that relates to the target 22 and is captured by the sensor 24. With respect to embodiments utilizing one or more optical sensors 24, target information is contained in or originates from the target image 26. Such an image is typically composed of various pixels. With respect to non-optical sensors 24, target information is some other form of representation, a representation that can typically be converted into a visual or mathematical format. For example, physical sensors 24 relating to earthquake detection or volcanic activity prediction can create output in a visual format although such sensors 24 are not optical sensors 24.

In many airbag embodiments, target informational 26 will be in the form of a visible light image of the occupant in pixels. However, the forms of target information 26 can vary more widely than even the types of sensors 24, because a single type of sensor 24 can be used to capture target information 26 in more than one form. The type of target information 26 that is desired for a particular embodiment of the sensor system 20 will determine the type of sensor 24 used in the sensor system 20. The image 26 captured by the sensor 24 can often also be referred to as an ambient image or a raw image. An ambient image is an image that includes the image of the target 22 as well as the area surrounding the target. A raw image is an image that has been captured by the sensor 24 and has not yet been subjected to any type of processing. In many embodiments, the ambient image is a raw image and the raw image is an ambient image. In some embodiments, the ambient image may be subjected to types of pre-processing, and thus would not be considered a raw image. Conversely, non-segmentation embodiments of the system 20 would not be said to segment ambient images, but such a system 20 could still involve the processing of a raw image.

D. Computer

A computer 40 is used to receive the image 26 as an input and generates a classification 32 as the output. The computer 40 can be any device or configuration of devices capable of performing the processing for generating a classification 32 from the image 26. The computer 40 can also include the types of peripherals typically associated with computation or information processing devices, such as wireless routers, printers, CD-ROM drives, etc.

The types of devices used as the computer 40 will vary depending on the type of application incorporating the classification system 20. In many embodiments of the classification system 20, the computer 40 is one or more embedded computers such as programmable logic devices. The programming logic of the classification system 20 can be in the form of hardware, software, or some combination of hardware and software. In other embodiments, the system 20 may use computers 40 of a more general purpose nature, computers 40 such as a desk top computer, a laptop computer, a personal digital assistant (PDA), a mainframe computer, a mini-computer, a cell phone, or some other device.

E. Attribute Vector

The computer 40 populates an attribute vector 28 with attribute values relating to preferably pre-selected characteristics of the sensor image 26 that are relevant to the application utilizing the classification system 20. The types of characteristics in the attribute vector 28 will depend on the goals of the application incorporating the classification system 20. Any characteristic of the sensor image 26 can be the basis of an attribute in the attribute vector 28. Examples of image characteristics include measured characteristics such as height, width, area, and luminosity as well as calculated characteristics such as average luminosity over an area or a percentage comparison of a characteristic to a predefined template.

Each entry in the vector of attributes 28 relates to a particular aspect or characteristic of the target information in the image 26. The attribute type is simply the type of feature or characteristic. Accordingly, attribute values are simply quantitative values for the particular attribute type in a particular image 26. For example, the height (an attribute type) of a particular object in the image 26 could be 200 pixels tall (an attribute value). The different attribute types and attribute values will vary widely in the various embodiments of the system 20.

Some attribute types can relate to a distance measurement between two or more points in the captured image 26. Such attribute types can include height, width, or other distance measurements (collectively “distance attributes”). In an airbag embodiment, distance attributes could include the height of the occupant or the width of the occupant.

Some attribute types can relate to a relative horizontal position, a relative vertical position, or some other position-based attribute (collectively “position attributes”) in the image 26 representing the target information. In an airbag embodiment, position attributes can include such characteristics at the upper-most location of the occupant, the lower-most location the occupant, the right-most location of the occupant, the left-most location of the occupant, the upper-right most location of the occupant, etc.

Attributes types need not be limited to direct measurements in the target information. Attribute types can be created by various combinations and/or mathematical operations. For example, the x and y coordinate for each “on” pixel (each pixel which indicates some type of object) could be added together, and the average for all “on” pixels would constitute a attribute. The average for the value of the x coordinate squared and the value of the y coordinate squared is also a potential attribute type. These are the first and second order moments of the image 26. Attributes in the attribute vector 28 can be evaluated in the form of these mathematical moments.

The attribute space that is filtered into the attribute vector 28 by the computer 40 will vary widely from embodiment to embodiment of the classification system 20, depending on differences relating to the target 22 or targets 22, the sensor 24 or sensors 24, and/or the target information in the captured image 26. The objective of the developing the attribute space is to define a minimal set of attributes that differentiates one class from another class.

One advantage of a sensor system 20 with pre-selected attribute types is that it specifically anticipates that the designers of the classification system 20 will create new and useful attribute types. Thus, the ability to derive new features from already known features is beneficial with respect to the practice of the invention. The present invention specifically provides ways to derive new additional features from those already existing features.

F. Classifier

A classifier 30 is any device that receives the vector of attributes 28 as an input, and generates one or more classifications 32 as an output. The logic of the classifier 30 can be embedded in the form of software, hardware, or in some combination of hardware and software. In some embodiments, the classifier 30 is a distinct component of the computer 40, while in other embodiments it may simply be a different software application within the computer 40.

In some embodiments of the sensor system 20, different classifiers 30 will be used to specialize in different aspects of the target 22. For example, in an airbag embodiment, one classifier 30 may focus on the static shape of the occupant, while a second classifier 30 may focus on whether the occupant's movement is consistent with the occupant being an adult. Multiple classifiers 30 can work in series or in parallel to enhance the goals of the application utilizing the classifications system 20.

G. Classification

A classification 32 is any determination made by the classifier 30. Classifications 32 can be in the form of numerical values or in the form of a categorical values of the target 22. For example, in an airbag embodiment of the system 20, the classification 32 can be a categorization of the type of the occupant. The occupant could be classified as an adult, a child, a rear facing infant seat, etc. Other classifications 34 in an airbag embodiment may involve quantitative attributes, such as the location of the head or torso relative to the airbag deployment mechanism. Some embodiments may involve both object type and object behavior classifications 32.

II. Vehicular Safety Restraint Embodiments

As identified above, there are numerous different categories of embodiments for the classification system 20. One category of embodiments relates to vehicular safety restraint applications, such as airbag deployment mechanisms. In some situations, it is desirable for the behavior of the airbag deployment mechanism to distinguish between different types of occupants. For example, in an a particular accident where the occupant is a human adult, it might be desirable for the airbag to deploy where, with the same accident characteristics, it would not be desirable for the airbag to deploy if the occupant is a small child, or an infant in a rear facing child seat.

A. Component View

FIG. 2 is a partial view of the surrounding environment for an automated safety restraint application (“airbag application”) utilizing the classification system 20. If an occupant 34 is present, the occupant 34 is likely sitting on a seat 36. In some embodiments, a video camera 42 or any other sensor 24 capable of rapidly capturing images is attached in a roof liner 38, above the occupant 34 and closer to a front windshield 44 than the occupant 34. The camera 42 can be placed in a slightly downward angle towards the occupant 34 in order to capture changes in the angle of the occupant's 34 upper torso resulting from forward or backward movement in the seat 36. There are many potential locations for a camera 42 that are well known in the art. Moreover, a wide range of different cameras 42 can be used by the airbag application, including a standard video camera that typically captures approximately 40 images per second. Higher and lower speed cameras 42 can be used by the airbag application.

In some embodiments, the camera 42 can incorporate or include an infrared or other light sources operating on constant current to provide constant illumination in dark settings. The airbag application can be designed for use in dark conditions such as night time, fog, heavy rain, significant clouds, solar eclipses, and any other environment darker than typical daylight conditions. Use of infrared lighting can assist in the capture of meaningful images 26 in dark conditions while at the same time, hiding the use of the light source from the occupant 40. The airbag application can also be used in brighter light and typical daylight conditions. Alternative embodiments may utilize one or more of the following: light sources separate from the camera; light sources emitting light other than infrared light; and light emitted only in a periodic manner utilizing modulated current. The airbag application can incorporate a wide range of other lighting and camera 42 configurations. Moreover, different heuristics and threshold values can be applied by the airbag application depending on the lighting conditions. The airbag application can thus apply “intelligence” relating to the current environment of the occupant 96.

As discussed above, the computer 40 is any device or group of devices, capable of implementing a heuristic or running a computer program (collectively the “computer” 40) housing the logic of the airbag application. The computer 40 can be located virtually anywhere in or on a vehicle. Moreover, different components of the computer 40 can be placed at different locations within the vehicle. In a preferred embodiment, the computer 40 is located near the camera 42 to avoid sending camera images through long wires or a wireless transmitter.

In the figure, an airbag controller 48 is shown in an instrument panel 46. However, the airbag application could still function even if the airbag controller 48 were placed in a different location. Similarly, an airbag deployment mechanism 50 is preferably located in the instrument panel 46 in front of the occupant 34 and the seat 36, although alternative locations can be used as desired by the airbag application. In some embodiments, the airbag controller 48 is the same device as the computer system 40. The airbag application can be flexibly implemented to incorporate future changes in the design of vehicles and airbag deployment mechanism 50.

Before the airbag deployment mechanism is made available to consumers, the attribute vector 28 in the computer 40 is preferably loaded with the particular types of attributes desired by the designers of the airbag application. The process of selecting which attributes types are to be included in the attribute vector 28 also should take into consideration the specific types of classifications 32 generated by the system 20. For example, if two pre-defined categories of adult and child need to be distinguished by the classification system 20, the attribute vector 28 should include attribute types that assist in distinguishing between adults and children. In a preferred embodiment, the types of classifications 32 and the attribute types to be included in the attribute vector 28 are predetermined, and based on empirical testing that is specific to the particular context of the system 20. Thus, in an airbag embodiment, actual human and other test “occupants” (or at the very least, actual images of human and other test “occupants”) are broken down into various lists of attribute types that would make up the pool of potential attribute types. Such attribute types can be selected from a pool of features or attribute types including features such as height, brightness, mass (calculated from volume), distance to the airbag deployment mechanism, the location of the upper torso, the location of the head, and other potentially relevant attribute types. Those attribute types could be tested with respect to the particular predefined classes, selectively removing highly correlated attribute types and attribute types with highly redundant statistical distributions.

B. Process Flow View

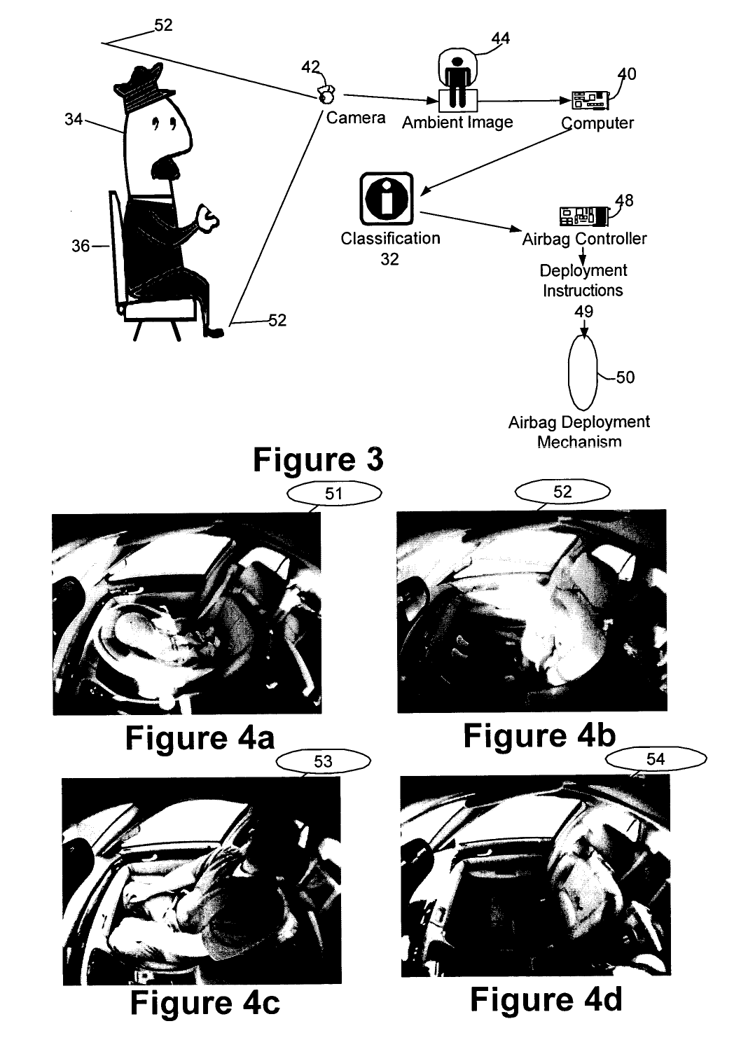

FIG. 3 discloses a high-level process flow diagram illustrating one example of the classification system 20 being used in the context of an airbag application. An ambient image 44 of a seat area 52 that includes both the occupant 34 and a surrounding seat area 52 can be captured by the camera 42. Thus, the ambient image 44 can include vehicle windows, the sear 36, the dashboard 46 and many other different objects both within the vehicle and outside the vehicle (visible through the windows). In the figure, the seat area 52 includes the entire occupant 34, although under many different circumstances and embodiments, only a portion of the occupant's 34 image will be captured, particularly if the camera 42 is positioned in a location where the lower extremities may not be viewable.

The ambient image 44 can be sent to the computer 40. The computer 40 receives the ambient image 44 as an input, and sends the classification 32 as an output to the airbag controller 48. The airbag controller 48 uses the classification 32 to create a deployment instruction 49 to the airbag deployment mechanism 50.

C. Predefined Classifications

In a preferred embodiment of the classification system 20 in an airbag application embodiment, there are four classifications 32 that can be made by the system 20: (1) adult, (2) child, (3) rear-facing infant seat, and (4) empty. Alternative embodiments may include additional classifications such as non-human objects, front-facing child seat, small child, or other classification types. Also alternative classifications may also use fewer classes for this application and other embodiments of the system 20. For example, the system 20 may classify initially as empty vs. non-empty. Then, if the image 26 is not an empty image then it may be classify into one of the following two classification options: (1) infant (2) All Else., or (1) RFIS (2) All Else. When the system 20 classifies the occupant as ‘All Else’ it should track the position of the occupant to determine if they are too close to the airbag for a safe deployment. FIG. 4a is a diagram of an image 26 that should be classified as a rear-facing infant seat 51. FIG. 4b is a diagram of an image 26 that should be classified as a child 52. FIG. 4c is a diagram of an image 26 that should be classified as an adult 53. FIG. 4d is a diagram of an image 26 that should be classified as an empty seat 54.

The predefined classification types can be the basis of a disablement decision by the system 20. For example, the airbag deployment mechanism 50 can be precluded from deploying in all instances where the occupant is not classified as an adult 53. The logic linking a particular classification 32 with a particular disablement decision can be stored within the computer 40, or within the airbag deployment mechanism 50. The system 20 can be highly flexible, and can be implemented in a highly-modular configuration where different components can be interchanged with each other.

III. Component-Based View

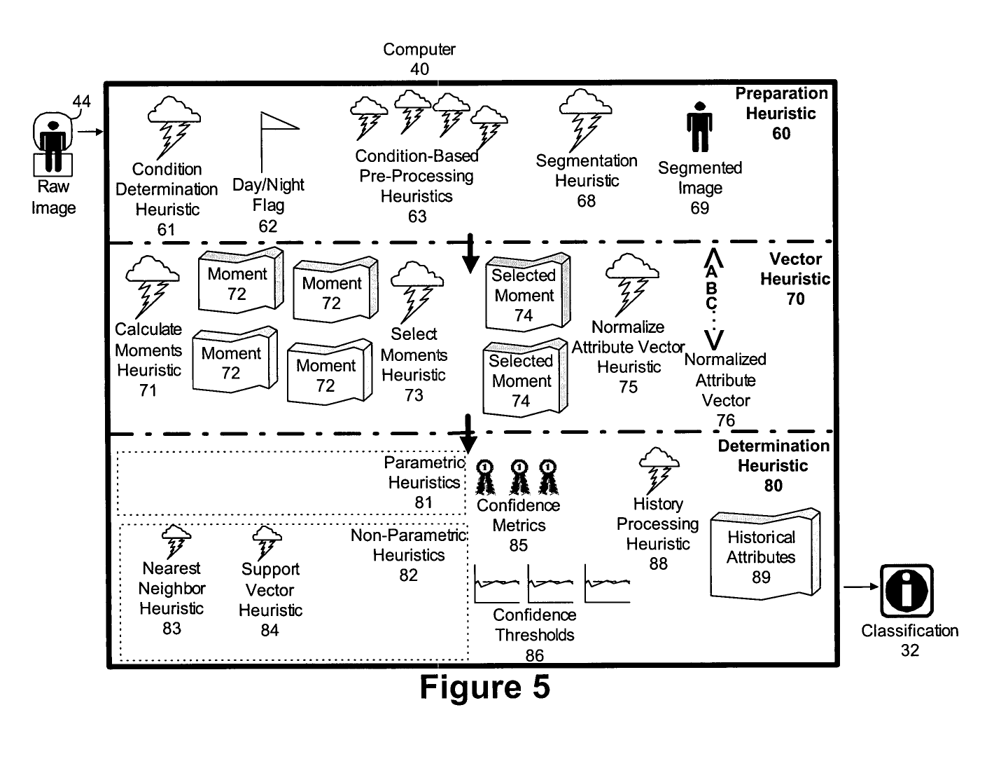

FIG. 5 is a block diagram illustrating a component-based view of the system 20. As illustrated in the figure, the computer 40 receives a raw image 44 as an input and generates a classification 32 as the output. As discussed above, a pre-processed ambient image 44 can also be used as a system 20 input. The raw image 44 can vary widely in the amount of processing that it is subjected to. In a preferred embodiment, the computer 40 performs all image processing so that the heuristics of the system 20 are aware of what modifications to the sensor image 26 have been made. In alternative embodiments, the raw or “unprocessed” image 26 may already have been subjected to certain pre-processing and image segmentation.

The processing performed by the computer 40 can be categorized into two heuristics, a feature vector generation heuristic 70 for populating the attribute vector 28 and a determination heuristic 80 for generating the classification 32. In a preferred embodiment, the senor image 26 is also subjected to various forms of preparation or preprocessing, including the segmentation of a segmented image 69 (an image that consists only of the target 22) from an ambient image or raw image 44, which also includes the area surrounding the target 22. Different embodiments may include different combinations of segmentation and pre-processing, with some embodiments performing only segmentation while other embodiments performing only pre-processing. The segmentation and pre-processing performed by the computer 40 can be referred to collectively as a preparation heuristic 60.

A. Image Preparation Heuristic

The image preparation heuristic 60 can include any processing that is performed between the capture of the sensor image 26 from the target 22 and the populating of the attribute vector 28. The order in which various processing is performed by the image preparation heuristic 60 can vary widely from embodiment to embodiment. For example, in some embodiments, segmentation can be performed before the image is pre-processed while in other embodiments, segmentation is performed on a pre-processed image.

1. Identification of Environmental Conditions

An environmental condition determination heuristic 61 can be used to evaluate certain environmental conditions relating to the capturing of the sensor image 26. One category of environmental condition determination heuristics 61 is a light evaluation heuristic that characterises the lighting conditions at the time in which the image 26 is captured by the sensor 24. Such a heuristic can determine whether lighting conditions are generally bright or generally dark. A light evaluation heuristic can also make more sophisticated distinctions such as natural outdoor lighting versus indoor artificial lighting. The environmental condition determination can be made from the sensor image 26, the sensor 24, the computer 30, or by any other mechanism employed by the application utilizing the system 20. For example, the fact that a particular image 26 was captured at nighttime could be evident by the image 26, the camera 42, a clock in the computer 40, or some other mechanism or process. The types of conditions being determined will vary widely depending on the application using the system 20. For embodiments involving optical sensors 24, relevant conditions will typically relate to lighting conditions. One potential type of lighting condition is the time of day. The condition determination heuristic 61 can be used to set a day/night flag 62 so that subsequent processing can be customized for day-time and night-time conditions. In embodiments of the system 20 not involving optical sensors 22, relevant conditions will typically not involve vision-based conditions. In an automotive embodiment, the lighting situation can be determined by comparing the effects of the infrared illuminators along the edges of the image 26 relative to the amount of light present in the vehicle window area. If there is more light in the window area than the edges of the image then it must be daylight. An empty reference image is stored for each of these conditions and then used in the subsequent de-correlation processing stage. FIG. 9 shows the reference images for each of the three lighting conditions. The reference images and FIG. 9 are discussed in greater detail below.

Another potentially relevant environmental condition for an imaging sensor 24 is the ambient temperature. Many low cost image generation sensors have significant increases in noise due to temperature. The knowledge of the temperature can set particular filter parameters to try to reduce the effects of noise or possibly to increase the integration time of the sensor to try to improve the image quality.

2. Segmenting the Image

A segmentation heuristic 68 can be invoked to create a segmented image 69 from the raw image 44 received into the system 20. In a preferred embodiment, the segmentation heuristic 68 is invoked before other preprocessing heuristics 63, but in alternative embodiments, it can be performed after pre-processing, or even before some pre-processing activities and after other pre-processing activities. The specific details of the segmentation heuristic may depend on the relevant environmental conditions. The system 20 can incorporate a wide variety of segmentation heuristics 68, and a wide variety of different combinations of segmentation heuristics.

3. Pre-Processing the Image

Given the relevant environmental conditions identified by the condition determination heuristic 61, an appropriate pre-processing heuristic 63 can be identified and invoked to facilitate accurate classifications 32 by the system 20. In a preferred airbag application embodiment, there will be at least one pre-processing heuristic 63 relating to daytime conditions and at least one pre-processing heuristic 63 relating to nighttime conditions. Edge detection processing is one form of pre-processing.

B. Feature (Moment) Vector Generation Heuristic

A feature vector generation heuristic 70 is any process or series of processes for populating the attribute vector 28 with attribute values. As discussed above and below, attribute values are preferably defined as mathematical moments 72.

1. Calculating the Features (Moments)

One or more different calculate moments heuristics 71 may be used to calculate various moments 72 from a two dimension image 26. In a preferred airbag embodiment, the moments 72 are Legendre orthogonal moments. The calculate moment heuristics 71 are described in greater detail below.

2. Selecting a Subset of Features (Moments)

Not all of the attributes that can be captured from the image 26 should be used to populate the vector of attributes 28. In contrast to human beings who typically benefit from each additional bit of information, automated classifiers 30 may be impeded by focusing on too many attribute types. A select feature heuristic 73 can be used to identify a subset of selected features 74 from all of the possible moments 72 that could be captured by the system 20. The process of identifying selected features 74 is described in greater detail below.

3. Normalizing the Feature Vector (Attribute Vector)

In a preferred embodiment, the attribute vector 28 sent to the classifier 30 is a normalized attribute vector 76 so that no single attribute value can inadvertently dominate all other attribute values. A normalize attribute vector heuristic 75 can be used to create the normalized attribute vector 76 from the selected features 74. The process of creating and populating the normalized attribute vector 76 is described in greater detail below.

C. Determination Heuristic

A determination heuristic 80 includes any processing performed from the receipt of the attribute vector 28 to the creating to the classification 32, which in a preferred embodiment is the selection of a predefined classification type. A wide variety of different heuristics can be invoked within the determination heuristic 80. Both parametric heuristics 81 (such as Bayesian classification) and non-parametric heuristics 82 (such as a nearest neighbor heuristic 83 or a support vector heuristic 84) may be included as determination heuristics 80. Such processing can also include a variety of confidence metrics 85 and confidence thresholds 86 to evaluate the appropriate “weight” that should be given to the application utilizing the classification 32. For example, in an airbag embodiment, it might be useful to distinguish between close call situations and more clear cut situations.

The determination heuristic 80 should preferably include a history processing heuristic 88 to include historical attributes 89, such as prior classifications 32 and confidence metrics 85, in the process of creating new updated classification determinations. The determination heuristic 80 is described in greater detail below.

IV. Subsystem View

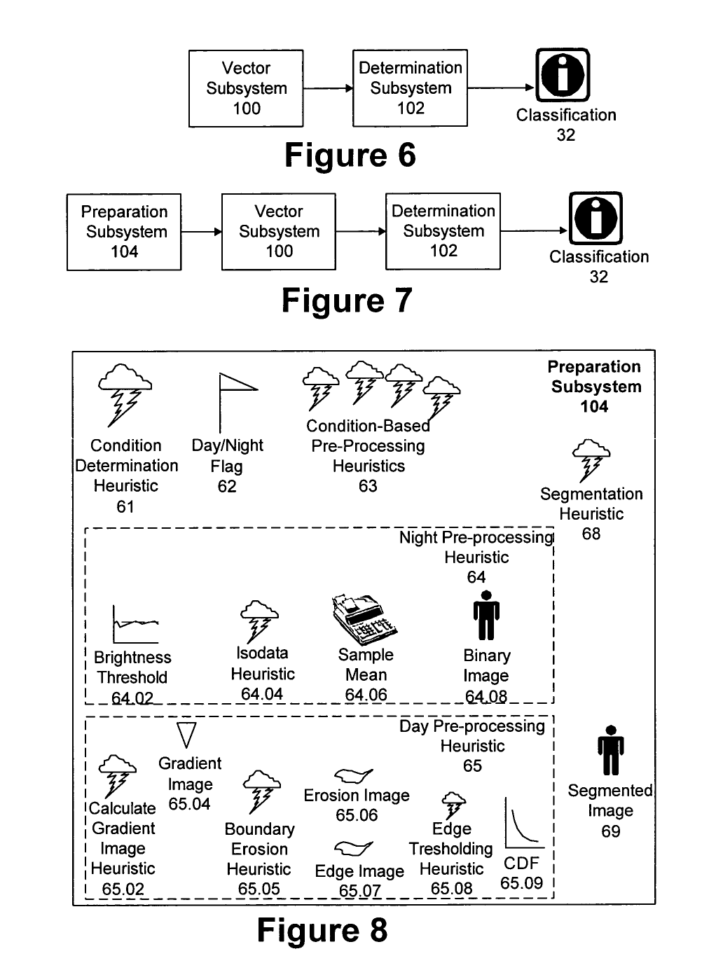

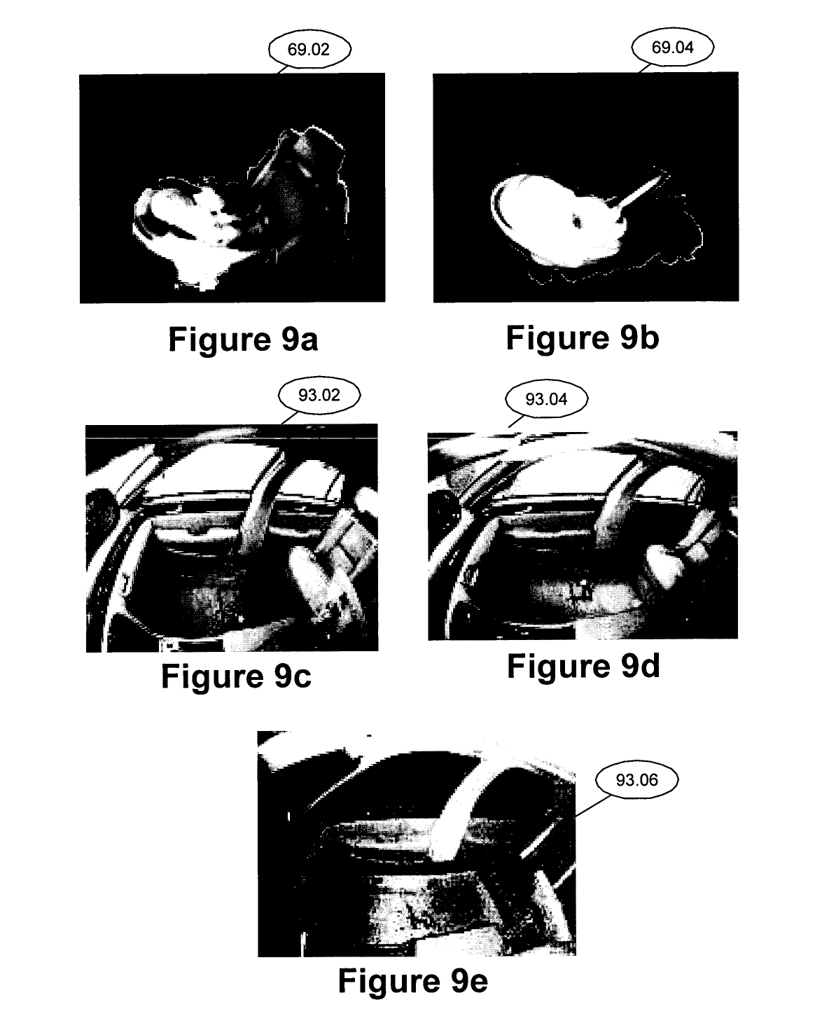

FIG. 6 illustrates an example of a subsystem-level view of the classification system 20 that includes only a feature vector generation subsystem 100 and a determination subsystem 102 in the process of generating an object classification 32. The example in FIG. 6 does not include any pre-processing or segmentation functionality. FIG. 7 illustrates an example of a subsystem-level view of an embodiment that includes a preparation subsystem 104 as well as the vector subsystem 100 and determination subsystem 102. FIGS. 8, 12, and 13 provide more detailed views of the individual subsystems.

A. Preparation Subsystem

FIG. 8 is a block diagram illustrating an example of the preparation subsystem 104. The preparation subsystem 104 is the subsystem responsible for performing one or more preparation heuristics 80. The image preparation subsystem 104 performs one or more of the preparation heuristics 60 as discussed above. The various sub-processes making up the preparation heuristic 60 can vary widely. The order of such sub-processes can also vary widely from embodiment to embodiment.

1. Environmental Condition Determination

The environmental condition determination heuristic 61 is used to identify relevant environmental factors that should be taken into account during the pre-processing of the image 26. In an airbag embodiment, the condition determination heuristic 61 is used to set a day/night flag 62 that can be referred to in subsequent processing. In a preferred airbag embodiment, a day pre-processing heuristic 65 is invoked for images 26 captured in bright conditions and a night pre-processing heuristic 64 is invoked for images 26 captured in dark conditions, including night-time, solar eclipses, extremely cloudy days, etc. In other embodiments, there may be more than two environmental conditions that are taken into consideration, or alternatively, there may not be any type of condition-based processing. The segmentation heuristic 68 may involve different processing for different environmental conditions.

2. Segmentation

In preferred embodiment of the system 20, a segmentation heuristic 68 is performed on the sensor image 26 to generate a segmented image 69 before any other pre-processing steps are taken. The segmentation heuristic 68 uses various empty vehicle reference images (which can also be referred to as test images or template images) as shown in FIGS. 9c, 9d, and 9e. The segmentation heuristic 68 can then determine what parts of the image being classified are different from the reference or template image. In an airbag embodiment of the system 20, any differences must correspond to the occupant 34. FIG. 9a illustrates an example of a segmented image 69.02 that originates from a sensor image 26 captured in daylight conditions (a “daylight segmented image” 69.02). FIG. 9b illustrates an example of a segmented image 69.04 that originates from a sensor image 26 captured in night-time conditions (a “night segmented image” 69.04). FIG. 9c illustrates an example of an outdoor lighting template image 93.02 used for comparison (e.g. reference) purposes with respect to images captured in well-lit conditions where the light originates from outside the vehicle. FIG. 9d illustrates an example of an indoor lighting template image 93.04 used for comparison (e.g. reference) purposes with respect to images captured in well-lit conditions where the light originates from inside the vehicle. 93.04. FIG. 9e illustrates an example of a dark template image 93.06 used for comparison (e.g. reference) purposes with respect images captured at night-time or otherwise dark lighting conditions. There are many different segmentation techniques, pre-defined environmental conditions, and template images that can incorporated into the processing of the system 20.

3. Environmental Condition-Based Pre-Processing

A wide variety of different pre-processing heuristics 63 can potentially be incorporated into the functioning of the system 20. In a preferred airbag embodiment, pre-processing heuristics 63 should include a night pre-processing heuristic 64 and a day pre-processing heuristic 65.

a. Night-Time Processing

A night pre-processing heuristic 64, the target 22 and the background portions of the sensor image 26 are differentiated by the contrast in luminosity. One or more brightness thresholds 64.02 can be compared with the various the luminosity characteristics of the various pixels in the inputted image (the “raw image” 44). In some embodiments, the brightness thresholds 64.02 are predefined, while in others they are calculated by the system 20 in real time based on the characteristics of recent and even current pixel characteristics. In embodiments involving the dynamic setting of the brightness threshold 64.02, an iterative isodata heuristic 64.04 can be used to identify the appropriate brightness threshold 64.02. The isodata heuristic 64.04 can use a sample mean 64.06 for all background pixels to differentiate between background pixels and the segmented image 69 in the form of a binary image 64.08. The isodata heuristic 64.04 is described in greater detail below.

b. Day-Time Processing

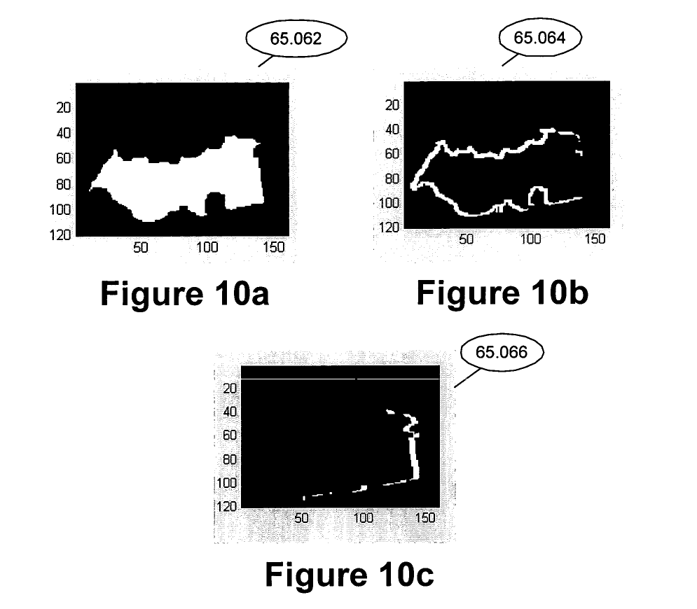

A day pre-processing heuristic 65 is designed to highlight internal features that will allow the classifier 30 to distinguish between the different classifications 32. A calculate gradient image heuristic 65.02 is used to generate a gradient image 65.04 of the segmented image 69. Gradient image processing converts the amplitude image into an edge amplitude image. A boundary erosion heuristic 65.05 can then be performed to remove parts of the segmented image 69 that should not have been included in the segmented image 69, such as the back edge of the seat in the context of an airbag application embodiment. By thresholding the image 26 in a manner as described with respect to night-time processing, a binary image (an image where each pixel representing the corrected segmented image 69 has one pixel value, and all background pixels have a second pixel value) is generated. FIG. 10a discloses a diagram illustrating one example of a binary image 65.062 in the context of day-time processing in an airbag application embodiment of the system 20. An edge image 65.07 representing the outer boundary of the binary image can then be eroded. FIG. 10b discloses an example of an eroded edge image 65.064 and FIG. 10c discloses an example of a seat contour image 65.066 that has been eroded off of the edge image 65.07. The boundary edge heuristic is described in greater detail below.

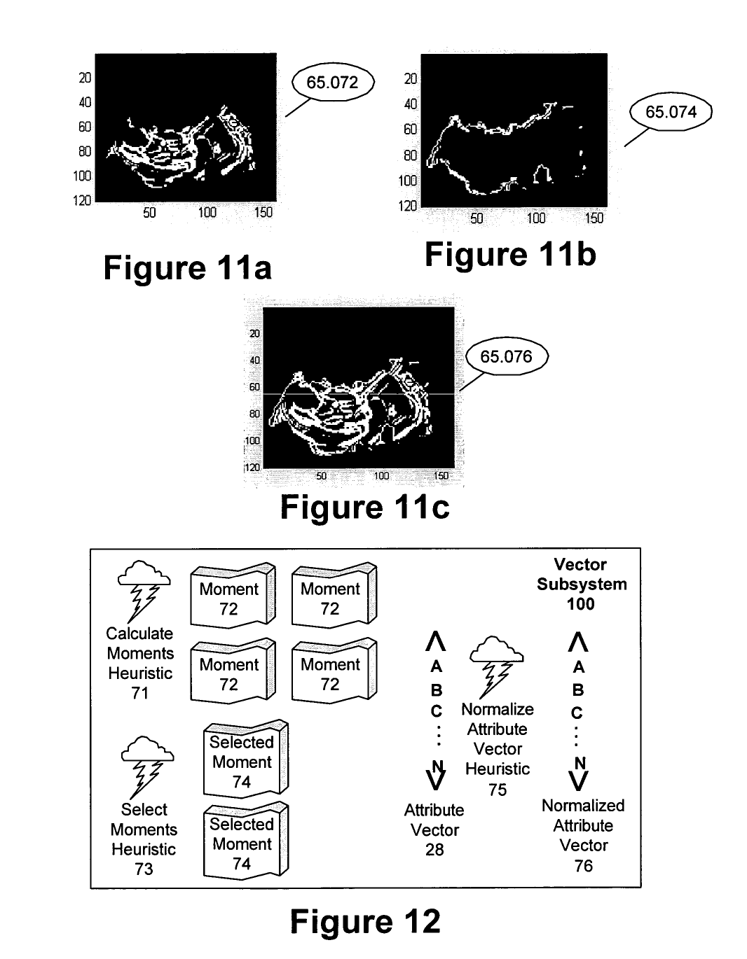

Returning to FIG. 8, an edge thresholding heuristic 65.08 can then be invoked, applying a cumulative distribution function 65.09 to further filter out pixels that may not be correctly attributable to the target 22. FIG. 11a discloses an example of a binary image (an “interior edge image” 65.072) where only edges that correspond to amplitudes greater than some N % of pixels (65% in the particular example) are considered to represent the target 22, with all other pixels being identified as relating to the background. Thresholding can then be performed to generate a contour edge image 65.074 as disclosed in FIG. 11b. FIG. 11c discloses a diagram of a combined edge Image 65.076, an image that includes the contour edge image 65.074 and the interior edge image 65.072. The edge thresholding heuristic 65.08 is described in greater detail below.

B. Vector Subsystem

A vector subsystem 100 can be used to populate the attribute vector 70 described both above and below. FIG. 12 is a block diagram illustrating some examples of the elements that can be processed by the feature vector generation subsystem 100.

A calculate moments heuristic 71 is used to calculate the various moments 72 in the captured and preferably pre-processed, image. In a preferred embodiment, the moments 72 are Legendre orthogonal moments. They are generated by first generating traditional geometric moments up to some predetermined order (45 in a preferred airbag application embodiment). Legendre moments can then be generated by computing weighted distributions of the traditional geometric moments. If the total order of the moments is set to 45, then the total number of attributes in the attribute vector 28 is 1081, a number that is too high. The calculate moments heuristic 71 is described in greater detail below.

A feature selection heuristic 73 can then be applied to identify a subset of selected moments 74 from the total number of moments 72 that would otherwise be in the attribute vector 28. The feature selection heuristic 73 is preferably pre-configured, based on the actual analysis of template or training images so that only attributes useful in distinguishing between the various pre-defined classifications 32 are included in the attribute vector 28.

A normalized attribute vector 76 can be created from the attribute vector 28 populated with the values as defined by the selected features 72. Normalized values are used to prohibit a strong discrepancy in a single value from having too great of an impact in the overall classification process.

C. Determination Subsystem

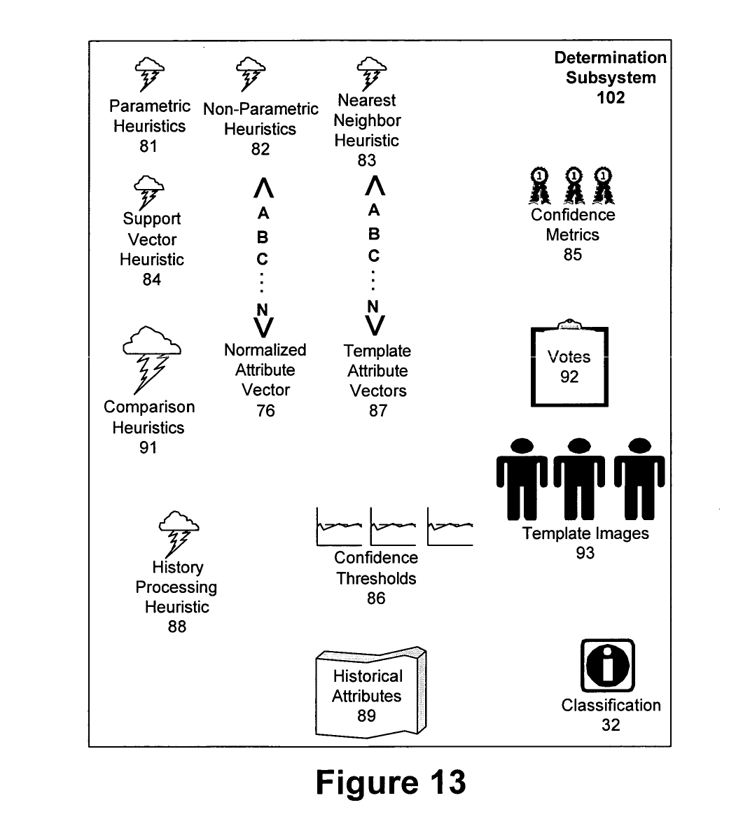

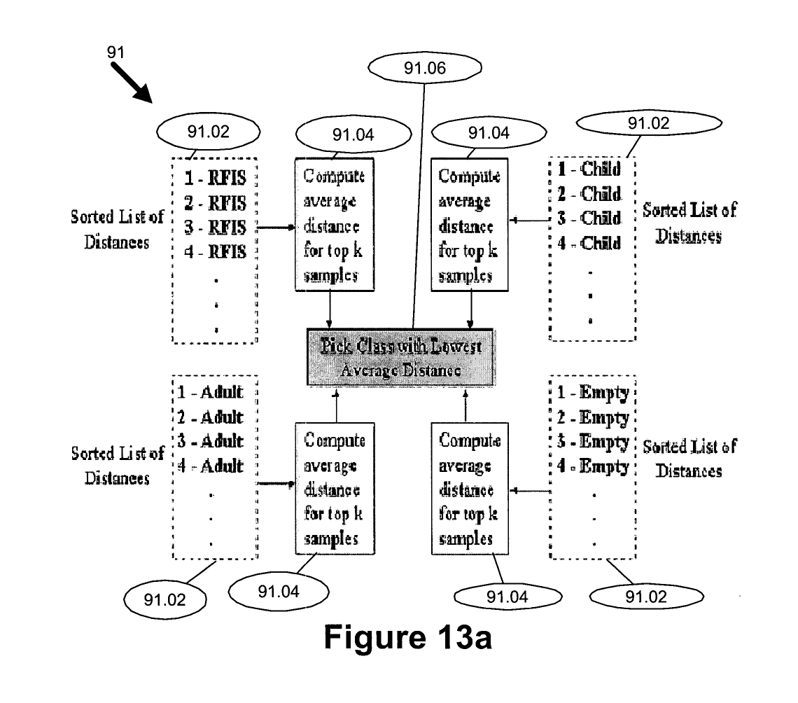

FIG. 13 is a block diagram illustrating an example of a determination subsystem 102. The determination subsystem 102 can be used to perform the determination heuristic 80 described both above and below. The classification subsystem 102 can perform parametric heuristics 81 as well as non-parametric heuristics 82 such as a k-nearest neighbor heuristic (“nearest neighbor heuristic” 83) or a support vector machine heuristic 84. In embodiments of the system 20 where there is extremely high variability in the target 22, including airbag application embodiments, it is preferable to use one or more non-parametric heuristics 82.

The various heuristics can be used to compare the attribute values in the normalized attribute vector 76 with the values in various stored training or template attribute vectors 87. For example, some heuristics may calculate the difference (Manhattan, Euclidean, Box-Cox, or Geodesic distance, collectively “distance metric”) between the example values from the training attribute vector set 87 and the attribute values in the normalized attribute vector 76. The example values are obtained from template images 93 where a human being determines the various correct classifications 32. Once the distances are computed, the top k distances (e.g. the smallest distances) can be determined by sorting the computed distances using a bubble sort or other similar sorting methodology. The system 20 can then generate various votes 92 and confidence metrics 85 relating to particular classification determinations. In an airbag embodiment, votes 92 for a rear facing infant seat 51 and a child 52 can be combined because in either scenario, it would be preferable in a disablement decision to preclude the deployment of the safety restraint device.

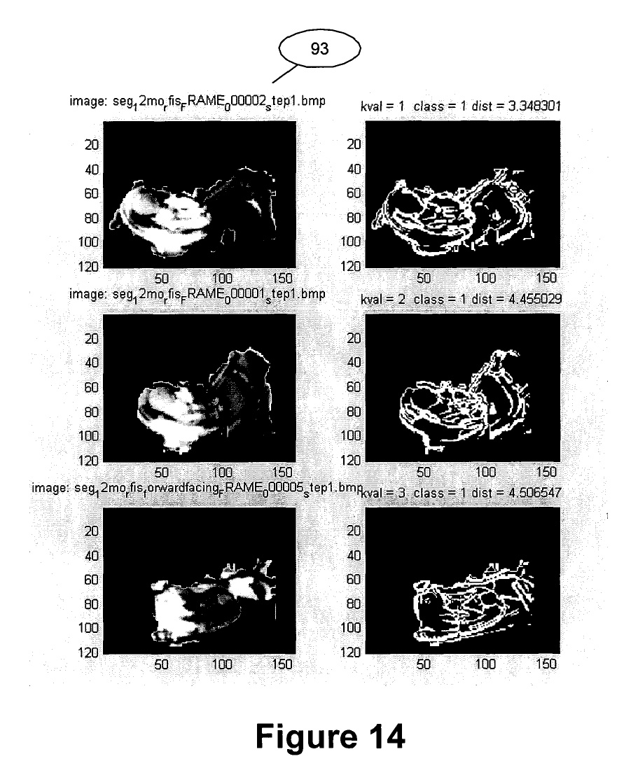

A confidence metric 85 is created for each classification determination. In FIG. 14, a diagram illustrating one example of a tabulation 93 of the various votes 92 generated by the system 20. Each determination concludes that the target 22 is a rear-facing infant seat 51, so the confidence metric 85 associated with that classification can be set to 1.0. The process of generating classifications 32 and confidence metrics 85 is described in greater detail below.

The system 20 can be configured to perform a simple k-nearest neighbor (“k-NN”) heuristic as the comparison heuristic 91. The system 20 can also be configured to perform an “average-distance” k-NN heuristic that is disclosed in FIG. 13a. The “average-distance” heuristic computes the average distance 91.04 of the test sample to the k-nearest training samples in each class 91.02 independently. A final determination 91.06 is made by choosing the class with the lowest average distance to its k-nearest neighbors. For example, the heuristic computes the mean for the top k RFIS training samples, the top k adult samples, etc. and then chooses the class with the lowest average distance.

This modified k-NN can be preferable to the traditional k-NN because its output is an average distance metric, namely the average distance to the nearest k-training samples. This metric allows the system 20 to order the possible blob combinations to a finer resolution than a simple m-of-k voting result without requiring us to make k too large. This metric of classification distance can then be used in the subsequent processing to determine the overall best segmentation and classification.

In some embodiments of the system 20, a median distance is calculated in order to generate a second confidence metric 85. For example, in FIG. 14, all votes 92 are for rear-facing infant seat (RFIS) 51 so the median RFIS distance is the median of the three distances (4.455 in the example). The median distance can then be compared against one or more confidence thresholds 86 as discussed above and illustrated in FIG. 13a. The process of generating second confidence metrics 85 to compare to various confidence thresholds 86 is discussed in greater detail below.

In a preferred embodiment of the system 20, historical attributes 89 are also considered in the process of generating classifications 32. Historical information, such as a classification 32 generated mere fractions of a second earlier, can be used to adjust the current classification 32 or confidence metrics 85 in a variety of different ways.

V. Process-Flow Views

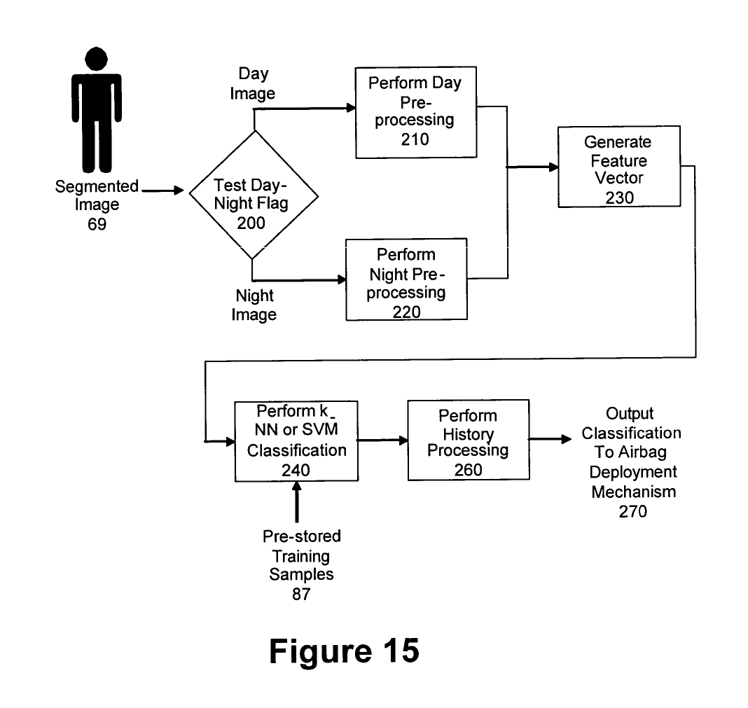

The system 20 can be configured to perform many different processes in generating the classification 32 relevant to the particular application invoking the system 20. The various heuristics, including a condition determination heuristic 61, a night pre-processing heuristic 64, a day pre-processing heuristic 65, a calculate moments heuristic 71, a select moments heuristic 73, the k-nearest neighbor heuristic 83, and other processes described both above and below can be performed in a wide variety of different ways by the system 20. The system 20 is intended to be customied to the particular goals of the application invoking the system. FIG. 15 is a process flow diagram illustrating one example of a system-level process flow that is performed for an airbag application embodiment of the system 20.

The input to system processing in FIG. 15 is the segmented image 69. As discussed above, the segmentation heuristic 68 performed by the system 20 can be done before, during, or after other forms of image pre-processing. In the particular example presented in the figure, segmentation is performed before the setting of the day-night flag at 200. However, subsequent processing does serve to refine the exact scope of the segmented image 69.

A. Day-Night Flag

A day-night flag is set at 200. This determination is generally made during the performance of the segmentation heuristic 68. The determination of whether the imagery is from a daylight condition or a night time condition based on the characteristics of the image amplitudes. Daylight images involve significantly greater contrast than nighttime images captured through the infrared illuminators used in a preferred embodiment in an airbag application embodiment of the system 20. Infrared illuminators result in an image 26 of very low contrast. The differences in contrast make different image pre-processing highly desirable for a system 20 needing to generate accurate classifications 32.

B. Segmentation

In a preferred embodiment of the system 20, a segmentation heuristic 68 is performed on the sensor image 26 to generate a segmented image 69 before any other pre-processing is performed on the image 26 but after the environmental conditions surrounding the capture of the image 26 have been evaluated. Thus, in a preferred embodiment, the image input to the system 20 is a raw image 44. In other embodiments and as illustrated in FIG. 15, the raw image 44 is segmented before the day-night flag is set at 200.

The segmentation heuristic 68 can use an empty vehicle reference image as discussed above and as illustrated in FIGS. 9c, 9d, and 9e. By comparing the appropriate template image 91 to the captured image 44, the system 20 can automatically determine what parts of the captured image 44 are different from the template image 91. Any differences should correspond to the occupant. FIG. 9a illustrates an example of a segmented image 69.02 that originates from a sensor image 26 captured in daylight conditions (a “daylight segmented image” 69.02). FIG. 9b illustrates an example of a segmented image 69.04 that originates from a sensor image 26 captured in night-time conditions (a “night segmented image” 69.04). There are many different segmentation techniques that can incorporated into the processing of the system 20. The preferred segmentation for an airbag suppression application involves the following processing stages: (1) De-correlation processing, (2) Adaptive Thresholding, (3) Watershed or Region Growing Processing.

1. De-correlation Processing

The de-correlation processing heuristic compares the relative correlation between the incoming image and the reference image. Regions of high correlation mean there is no change from the reference image and that region can be ignored. Regions of low correlation are kept for the further processing. The images are initially converted to gradient, or edge, images to remove the effects of variable illumination. The processing then compares the correlation of a N×N patch as it is convolved across the two images. The de-correlation map is computed using
Equation 1:

$$C = \frac{{\sum }_{A} {\sum }_{B} {g}_{1} ( x , y ) \cdot {g}_{2} ( x , y )}{\sqrt{{\sum }_{A} {{g}_{1} ( x , y )}^{2} \cdot {\sum }_{B } {{g}_{2} ( x , y )}^{2}}}$$

2. Adaptive Thresholding.

Once the de-correlation value for each region is determined an adaptive threshold heuristic can be applied and any regions that fall below the threshold (a low correlation means a change in the image) can be passed onto the Watershed processing.

3. Watershed or Region Growing Processing

The Watershed heuristic uses two markers, one placed on where the occupant is expected and the other placed on the where the background is expected. The initial occupant markers are determined by two steps. First the de-correlation image is used as a mask into the incoming image and the reference image. Then the difference of these two images is formed over this region and thresholded. This thresholding of this difference image at a fixed percentage, then generates the occupant marker. The background marker is defined as the region that is outside the cleaned up de-correlation image. The watershed is executed once and the markers are updated based on the results of this first process. Then a second watershed pass is executed with these new markers. Two passes of watershed have been shown to be adequate at removing the background while minimizing the intrusion into the actual occupant region.

C. Night Pre-Processing

If the day-night flag at 200 is set to night, night pre-processing can be performed at 220. FIG. 17 is a process flow diagram illustrating an example of how night pre-processing is performed. The contrast between the target and background portions of the captured image 26 is such that they can be separated by a simple thresholding heuristic. In some embodiments, the appropriate brightness threshold 64.02 is predefined. In other embodiments, it is determined dynamically by the system 20 at 222 through the invocation of an isodata heuristic 64.04. With the appropriate brightness threshold, a silhouette of the target 22 can be extract at 224.

1. Calculating the Threshold

An iterative technique, such as the isodata heuristic 64.04, is used to choose a brightness threshold 64.02 in a preferred embodiment. The noisy segment is initially grouped into two parts (occupant and background) using a starting threshold value 64.02 such as θ₀=128, which is half of the image dynamic range of pixel values (0-255). The system 20 can then compute the sample gray-level mean for all the occupant pixels (M_{o,0}) and the sample mean 64.06 for all the background pixels (M_{b,0}). A new threshold θ₁ can be updated as the average of these two means.

The system 20 can keep repeating this process, based upon the updated threshold, until no significant change is observed in this threshold value between iterations. The whole process can be formulized as illustrated in Equation 2:
θₖ=(M_{o,k-1}+M_{b,k-1})/2 until θₖ=θₖ₋₁

2. Extracting the Silhouette

Once the threshold θ is determined at 222, the system 20 at 224 can further refine the noisy segment by thresholding the night images f(x,y) using Equation 3:
If f(x,y)≧θ f(x,y)=1∈occupant Else f(x,y)=0∈background
The resultant binary image 64.08 should be treated as the occupant silhouette in the subsequence step of feature extraction.

D. Daytime Pre-Processing

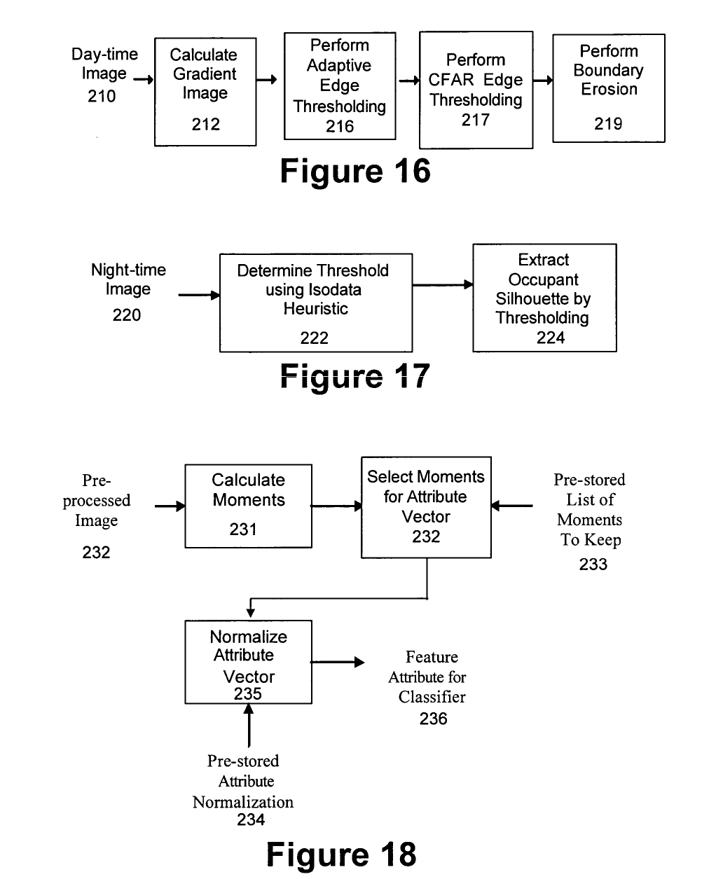

Returning to FIG. 15, if the test flag at 200 is set to daytime, day pre-processing is performed at 210. An example of daytime preprocessing is disclosed in greater detail in FIG. 16. The daylight pre-processing heuristic 65 is designed to highlight internal features that will allow the classifier 30 to distinguish between the different pre-defined classifications 32. The daytime pre-processing heuristic 65 includes a calculation of the gradient image 65.04 at 212, the performance of a boundary erosion heuristic 65.05 at 214, and the performance of an edge thresholding heuristic 65.08 at 216.

1. Calculating the Gradient Image

If the incoming raw image is a daytime image, a gradient image 65.04 is calculated with a gradient calculation heuristic 65.02 at 212. The gradient image heuristic 65.02 converts an amplitude image into an edge amplitude image. There are other operators besides gradient that can perform this function, including Sobel or Canny Edge operators. This processing computes the row-direction gradient (row_gadient) and the column-direction gradient (col_gadient) at each pixel and then computes the overall edge amplitude as identified in Equation 4:
edge_ampl=sqrt(row_gadient²+col_gadient²).

2. Adaptive Edge Thresholding

Returning to the process flow diagram illustrated in FIG. 16, the system performs adaptive edge thresholding at 216. The adaptive threshold generates a histogram and the corresponding cumulative distribution function (CDF) 65.09 of the edge image 65.07. Only edges that correspond to amplitudes greater than for example 65% of the pixels are set to one and the remaining pixels are set to zero. This generates an image 65.072 as shown in FIG. 11a. Then the same threshold is used to keep the outer contour edge amplitudes, e.g. the edges 65.064 that were located in the mask shown in FIG. 10b. The results of this operation is shown in FIG. 11b. Both of these images are combined and produce an image as shown in FIG. 11c. This combined edge information image 65.076 serves as the input for invoking attribute vector 28 processing

3. CFAR Edge Thresholding

The actual edge detection processing is a two stage process, the second stage being embodied in the performance at 217 of a CFAR edge thresholding heuristic. The initial stage at 216 processes the image with a simple gradient calculator, generating the X and Y directional gradient values at each pixel. The edge amplitude is then computed and used for subsequent processing. The second stage is a Constant False Alarm Rate (CFAR) based detector. This has been shown for this type of imagery (e.g. human occupants in an airbag embodiment) to be superior to a simple adaptive threshold for the entire image in uniformly detecting edges across the entire image. Due to the sometimes severe lighting conditions where one part of the image is very dark and another is very bright, a simple adaptive threshold detector would often miss edges in an entire region of the image if it was too dark.

The CFAR method used is the Cell-Averaging CFAR where the average edge amplitude in the background window is computed and compared to the current edge image. Only the pixels that are non-zero are used in the background window average. Other methods such as Order Statistic detectors have been shown to be very powerful, such as a nonlinear filter. The guard region is simply a separating region between the test sample and the background calculations. For the results in this paper a total CFAR kernel of 5×5 is used. The test sample is simply a single pixel whose edge amplitude is to be compared to the background. The edge is kept if the ratio of the test sample amplitude to the background region statistic exceeds a threshold as shown in Equation 5:

$$edge = \frac{{text}_{—} pixel}{1 / n Σ background} > Threshold .$$

4. Boundary Erosion

A boundary erosion heuristic 65.05 that is invoked at 219 has at least two goals in an airbag embodiment of the system 20. One purpose of the boundary erosion heuristic 65.05 is the removal of the back edge of the seat which nearly always occurs in the segmented images as can be seen in FIG. 9a.

The first step is to simply threshold the image and create a binary image 65.062 as shown in FIG. 10a. Then a 8×8 neighborhood image erosion is performed which reduces the size of this binary image 65.062. The erosion image 65.06 is subtracted from the binary image 65.062 to generate a image boundary. This boundary is then eroded using a rearward erosion that starts at the far left of the image and erodes a 8-pixel wide region at the first non-zero set of pixels as the window moves forward in the image. The result of this processing is the boundary is divided into a contour and a back-of seat contour as shown in FIGS. 10b and 10c. The image 65.066 in FIG. 10c is used first as a mask to discard any edge information in the edge image 65.07 developed above. The image 65.064 in FIG. 10b is then used to extract any edge information corresponding to the exterior boundary of the image. These edges are usually very high amplitude and so are treated separately to allow increased sensitivity for detecting interior edges. The remaining edge image 65.07 is then fed to the next stage of the processing.

E. Generating the Attribute Vector

The attribute vector 28 can also be referred to as a feature vector 28 because features are characteristics or attributes of the target 22 that are represented in the sensor image 26. Returning to FIG. 15, an attribute vector 28 is generated at 230. The vector heuristic 70 of converts the 2-dimensional edge image 65.07 into a 1-dimensional attribute vector 28 which is an optimal representation of the image to support classification. The processing for this is defined in FIG. 18. The vector heuristic can include the calculating of moments at 231, the selection of moments for the attribute vector at 232, and the normalizing of the attribute vector at 235.

1. Calculating Moments.

The moments 72 used to embody image attributes are preferably Legendre orthogonal moments. Legendre orthogonal moments represent a relatively optimal representation due to their orthogonality. They are generated by first generating all of the traditional geometric moments 72 up to some order. In an airbag embodiment, the system 20 should preferably generate them to an order of 45. The Legendre moments can then generated by computing weighted combinations of the geometric moments. These values are then loaded into a attribute vector 28. When the maximum order of the moments is set to 45, then the total number of attributes at this point is 1081. Many of these values, however, do not provide any discrimination value between the different possible predefined classifications 32. If they were all to used in the classifier 30, then the irrelevant attributes would just be adding noise to the decision and make the classifier 30 perform poorly. The next stage of the processing then removes these irrelevant attributes.

2. Selecting Moments

In a preferred embodiment, moments 72 and the attributes they represent are selected during the off-line training of the system 20. By testing the classifier 30 with a wide variety of different images, the appropriate attribute filter can be incorporated into the system 20. The attribute vector 28 with the reduced subset of selected moments can be referred to as a reduced attribute vector or a filtered attribute vector. In a preferred embodiment, only the filtered attribute vector is passed along for normalization at 235.

3. Normalize the Feature Vector

At 235, a normalize attribute vector heuristic 75 is performed. The values of the Legendre moments have tremendous dynamic range when initially computed. This can cause negative effects in the classifier 30 since large dynamic range features inherently weight the distance calculation greater even if they should not. In other words, a single attribute could be given disproportionate weight in relation to other attributes. This stage of the processing normalizes the features to each be either between 0 and 1 or to be of mean 0 and variance 1. The old_attribute is the non-normalized value of the attribute being normalized. The actual normalization coefficients (scale_value_{—}1 and scale_value_{—}2) are preferably pre-computed during the off-line training phase of the program. The normalization coefficients are preferably pre-stored in the system 20 and used here according to Equation 6:
normalized_attribute=(old_attribute−scale_value_{—}1)/scale_value_{—}2

F. Classification Heuristics

Returning to FIG. 15, the system 20 at 240 performs some type(s) of classification heuristic, which can be a parametric heuristic 81 or preferably, a non-parametric heuristic 82. The k-nearest neighbor heuristic (k-NN) 83 and support vector heuristic 84 are examples of non-parametric heuristics 82 that are effective in an airbag application embodiment. In a preferred airbag embodiment, the k-NN heuristic 83 is used. Due to the immense variability of the occupants in airbag applications, a non-parametric approach is desirable. The class of the k closest matches is used as the classification of the input sample.

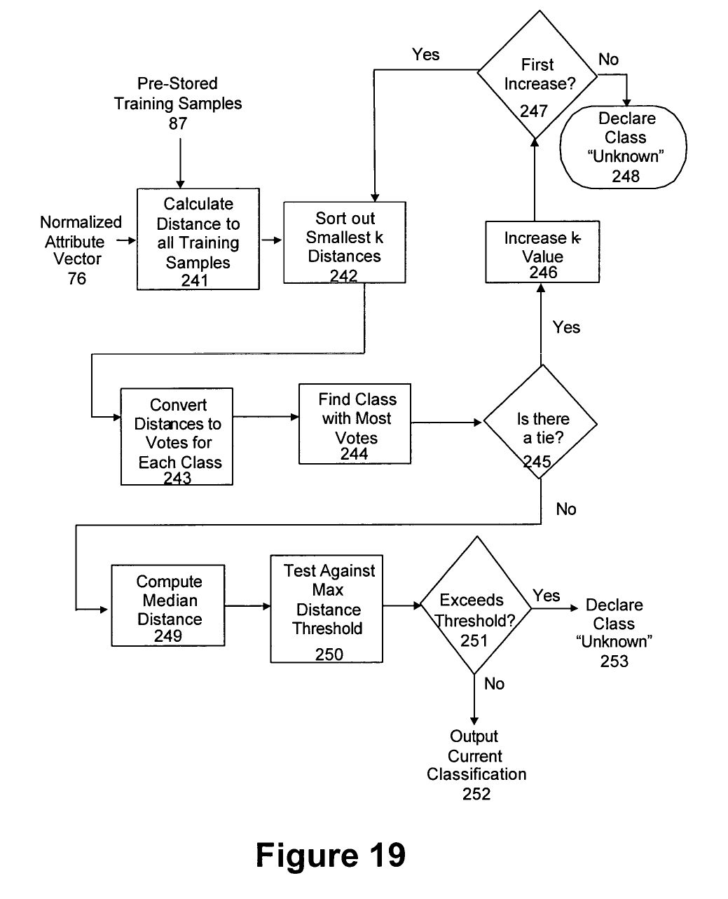

FIG. 19 discloses a process flow diagram that illustrates an example of classifier 30 functionality involving the k-NN heuristic 83. An example of typical output of the k-Nearest Neighbor for k=3 is shown in FIG. 14, as discussed above. Note the three closest matches for an input of RFIS were RFIS in the FIG. 14 example. The distances between the attribute vector 28 and template vector are shown in FIG. 14. Returning to FIG. 19, the following processes are disclosed: at 241 is the calculating

1. Calculating Differences

At 241, the system 20 calculates the distance between the moments 72 in the attribute vector 28 (preferably a normalized attribute vector 76) against the test values in the template vectors for each classification type (e.g. class). The attribute vector 28 should be compared to every pre-stored template vector in the training database that is incorporated into the system 20. In a preferred embodiment, the comparison between the sensor image 26 and the template images 93 is in the form of a Euclidean distance metric between the corresponding vector values.

2. Sort the “Distances”

At 242, the distances are sorted by the system 20. Once the distances are computed, the top k are determined by performing a partial bubble sort on the distances. The distances do not need to be completely sorted but only the smallest k values found. The value of k can be predefined, or set dynamically by the system 20.

3. Convert the Distances into Votes

At 243, the sorted distances are converted into votes 92. Once the smallest k values are found, a vote 92 is generated for each class (e.g. predefined classification type_ for which one of these smallest k correspond. In the example provided in FIG. 14, each of the votes 92 supported the classification 32 of RFIS (classification 1). If the votes are not unanimous, then the votes 92 for the RFIS and the child classes are combined by adding the votes from the smaller of the two into the larger of the two. If they are equal it is called a RFIS and the votes 92 are given to the RFIS class. The distinction between RFIS and child classes is likely an arbitrary, since the result of both the RFIS and the child class should be to disable the airbag. At 244, the system 20 determines which class has the most votes. If there is a tie at 245, for example in the k=3 class one vote is for RFIS, one for adult, and one for empty, then the k-value is increased at 246 by 2 (e.g. k=3 becomes a k=5 classifier) and these new k smallest distance values are used to vote. If there is still a tie after this the class is declared unknown at 248 since there is no compelling data for any of the classes. The number of votes relative to the k-value is used as a confidence measure or confidence metric 85. In the example in FIG. 14 all three are RFIS for a k=3 classifier so the RFIS decision would have confidence=1 corresponding to a probability of 1.0.

4. Confirm Results

At 249, the system 20 calculates a median distance as a second confidence metric 85 and tests the median distance against the test threshold at 250. The median distance for the correct class votes is used as a secondary confidence metric 85. For the example in FIG. 14, since all three votes are for RFIS, the median RFIS distance is the median of the three or dist_median=4.455. This median distance is then tested against a threshold, which can be predefined, or generated dynamically. If the distance is too great then it means that while a classification 32 was found, it is so different from what was expected for that class that we are no longer confident in the decision and the class is then declared “unknown” at 253. If the median distance passes the threshold, then the classification, the confidence, and the median distance are all forwarded to a module for incorporating history-related processing at 252.

G. History-Based Processing

The history processing takes the classification 32 and the corresponding confidence metrics 85 and tries to better estimate the classification of the occupant. The processing can assist in reducing false alarms due to occasional bad segmentations or situations such as the occupant pulling a sweater over their head and the image is not distinguishable. The greater the frequency of sensor measurements, the closer the relationship one would expect between the most recent past and the present. In an airbag application embodiment, internal and external vehicle sensors 24 can be used to preclude dramatic changes in occupant classification 32.

### VI. Alternative Embodiments

In accordance with the provisions of the patent statutes, the principles and modes of operation of this invention have been explained and illustrated in preferred embodiments. However, it must be understood that this invention may be practiced otherwise than is specifically explained and illustrated without departing from its spirit or scope.

1. A classification system comprising:
a vector subsystem, including a sensor image and a feature vector, wherein said vector subsystem provides for generating said feature vector from said sensor image; and
a determination subsystem, including a classification, a first confidence metric, and a historical characteristic, wherein said determination subsystem provides for generating said classification from said feature vector, said first confidence metric, and said historical characteristic.

2. The system of claim 1, said determination subsystem further including a second confidence metric, wherein said determination subsystem provides for generating said classification with said second confidence metric.

3. The system of claim 1, wherein said historical characteristic comprises a prior classification and a prior confidence metric.

4. The system of claim 1, wherein said sensor image is captured by a digital camera.

5. The system of claim 1, wherein said sensor image is in the form of a two-dimensional representation.

6. The system of claim 1, wherein said sensor image is in the form of an edge image.

7. The system of claim 1, further comprising a airbag deployment mechanism, said airbag deployment mechanism including a disablement decision, wherein said airbag deployment mechanism provides for generating said disablement decision from said classification.

8. The system of claim 1, further comprising a image processing subsystem, said image processing subsystem including a raw sensor image, wherein said sensor image processing subsystem generates said sensor image from said raw sensor image.

9. The system of claim 8, wherein said image processing subsystem performs a light evaluation heuristic to set a brightness value.

10. The system of claim 9, wherein said sensor image processing subsystem further includes a plurality of processing heuristics, wherein said sensor image processing subsystem provides for selectively invoking one or more of said processing heuristics using said brightness value.

11. The system of claim 9, wherein said light evaluation heuristic is a day-night determination heuristic and said brightness value is a day-night flag capable of being set to a value of day or a value of night.

12. The system of claim 11, wherein a day-night flag value of day triggers said sensor image processing subsystem to perform a day processing heuristic.

13. The system of claim 12, wherein said day processing heuristic comprises at lease one of a gradient image heuristic, a boundary erosion heuristic, and an adaptive edge thresholding heuristic.

14. The system of claim 11, wherein a day-night flag value of night triggers said sensor image processing subsystem to perform a night processing heuristic.

15. The system of claim 14, wherein said night processing heuristic comprises at least one of a brightness threshold heuristic and a silhouette extraction heuristic.

16. The system of claim 1, wherein said feature vector comprises a plurality of Legendre orthogonal moments.

17. The system of claim 1, wherein said feature vector comprises a plurality of normalized feature values.

18. The system of claim 1, wherein said determination subsystem provides for invoking a k-nearest neighbor heuristic to generate said classification.

19. The system of claim 18, wherein said k-nearest neighbor heuristic comprises a distance heuristic.

20. The system of claim 19, wherein said distance heuristic calculates a Euclidean distance metric.

21. The system of claim 1, wherein said determination subsystem accesses a historical classification and a historical confidence metric to generate said classification.

22. An airbag deployment system, comprising:
a plurality of pre-defined occupant classifications;
a camera for capturing a raw image;
a computer, including an edge image and vector of features, wherein said computer generates said edge image from said raw image, wherein said vector of features is loaded from said edge image, and wherein one classification within said plurality of pre-defined occupant classifications is selectively identified by said computer from said vector of features; and
an airbag deployment mechanism, including a classification and an airbag deployment determination, wherein said airbag deployment mechanism provides for generating said airbag deployment determination from said classification.

23. The system of claim 22, further comprising a day-night flag, wherein said computer further includes a plurality of processing heuristics from generating said edge image from said raw image, and wherein said computer uses said day-night flag to selectively identify one said processing heuristic from said plurality of processing heuristics.

24. The system of claim 22, wherein said vector of features comprise a plurality of Legendre orthogonal moments.

25. The system of claim 22, wherein said computer calculates a Euclidean distance metric from said vector of features by invoking a k-nearest neighbor heuristic.

26. The system of claim 22, wherein a ranking heuristic is performed to calculate a first confidence metric and a median distance heuristic is invoked to compute a second confidence metric, wherein said computer selectively identifies said classification with said first confidence metric and said second confidence metric.

27. The system of claim 22, wherein a said computer accesses a historical characteristic before said computer generates said classification.

28. A method for classifying an image, comprising:
capturing a visual image of a target;
making a day-night determination from the visual image of the target;
selecting a image processing heuristic on the basis of the day-night determination;
converting the visual image into an edge image with the selecting image processing heuristic;
populating a vector of features with feature values extracted from the edge image; and
generating a classification from the vector of features.

29. The method of claim 28, further comprising selectively disabling an airbag deployment mechanism when said classification is one of a plurality of pre-determined classifications requiring the disablement of the airbag deployment mechanism.

30. The method of claim 28, wherein the classification is generated from a historical characteristic of the target.

31. The method of claim 28, wherein the classification is generated from a confidence metric derived from a distance heuristic.
